(19) United States
(12) Patent Application Publication
(10) Pub. No.: US 2007/0295836 A1
(43) Pub. Date: Dec. 27, 2007

(54) POWDER DELIVERY METHOD AND APPARATUS

(75) Inventor: Alexander I. Jittu, Chesterfield, MI (US)

Correspondence Address: YOUNG & BASILE, P.C., 3001 WEST BIG BEAVER ROAD, SUITE 624, TROY, MI, 48084, US

(73) Assignee: DURR SYSTEMS, INC., Auburn Hills, MI (US)

(21) Appl. No.: 11/760,342

(22) Filed: Jun. 8, 2007

Related U.S. Application Data
(60) Provisional application No. 60/811,813, filed on Jun. 8, 2006.
(60) Provisional application No. 60/813,578, filed on Jun. 14, 2006.

(51) Int. Cl. B05B 7/04

(52) U.S. Cl. 239/398; 239/311

(57) ABSTRACT

A method and apparatus for transporting paint powder between first and second locations with at least one positive pressure air flow. One or more positive pressure air flows can transfer paint powder from a tote to a first hopper, from a virgin hopper to one or more mix hoppers, from a reclaim hopper to one or more mix hoppers, from one of the mix hoppers through one or more multidirectional valves to one or more final feed hoppers and/or positive pressure air flow final feed powder pumps located in a first position, and from one of the mix hoppers through one or more multidirectional valves to one or more final feed hoppers and/or positive pressure air flow final feed powder pumps located in a second position.

### CROSS-REFERENCE TO RELATED APPLICATIONS

This application claims the benefit of U.S. Provisional Application Nos. 60/811,813 and 60/813,578, which are incorporated by reference herein in their entirety.

### FIELD OF THE INVENTION

The invention relates to a powder paint transport system and a method used for powder paint preparation located remotely from a point of powder paint application.

### BACKGROUND

In a typical powder paint transport system, powder paint is supplied from a bag or tote to one or more virgin hoppers, from virgin hoppers to one or more mix hoppers, and from reclaim hoppers to one or more mix hoppers through negative pressure devices (vacuum type). The powder paint is pulled from the bag, or tote, or mix hopper, or reclaim hopper, or virgin hopper via vacuum pressure (negative pressure) and transported to a destination in a dilute phase at a relatively high velocity, typically up to 15 meters per second (m/sec).

There are a number of disadvantages associated with negative pressure based systems. For example, a negative pressure based system requires large diameter hoses, or stainless steel pipes, and are maintenance intensive. In addition, the dilute phase transportation of powder paint at relatively high speeds can mechanically damage the powder particles, causing the final quality of the powder paint to be not as high as expected.

### SUMMARY

It would be desirable to provide a powder transport system which is capable of transmitting large quantities of powder material over long distances at relatively high flow rates while maintaining the desired density and particle distribution which requires very little maintenance and service It would be desirable for a powder paint delivery method and apparatus to provide a very consistent supply of powder without the inconvenience of frequent maintenance, that uses minimal compressed air, and applies only low forces on the powder to minimize or eliminate damage caused during transportation. It would be desirable to employ a dense phase powder transfer, where there are no wearing surfaces to cause variation in flow over time due to erosion. An apparatus and method for powder delivery and distribution according to an embodiment of the invention includes a positive pressure air flow for transferring powder paint between first and second locations.

According an embodiment of a method for transporting powder paint between first and second locations, a positive pressure air flow transfers the powder paint from a first location to a second location, such as by way of example and not limitation, from a tote to a first hopper. A second positive pressure air flow can then transfer the powder paint from the first hopper, such as a virgin hopper, through a first multidirectional valve to one or more of a plurality of mix hoppers. A third positive pressure air flow can transfer powder paint from a reclaim hopper through a second multidirectional valve to one or more of the plurality of mix hoppers. Then a fourth positive pressure air flow can transfer the paint powder from one of the mix hoppers through a third multidirectional valve to a first three-way multidirectional valve and then transfer the powder from the first three-way multidirectional valve to one of a plurality of final feed hoppers and/or positive pressure air flow final feed powder pumps located in a first position through a first plurality of two-way multidirectional valves. At the same time, a fifth positive pressure air flow can transfer the powder paint from one of the plurality of mix hoppers through a fourth multidirectional valve to a second three-way multidirectional valve and then transfer the powder from the second three-way multidirectional valve to one of a plurality of final feed hoppers and/or positive pressure air flow final feed powder pumps located in a second position through a plurality of two-way multidirectional valves.

An apparatus for transferring powder paint between first and second locations can include a first positive pressure air flow pump connected to a tote containing powder paint. Discharge from the first positive pressure air flow pump can be connected to a virgin hopper to be filled with powder paint. The positive pressure air flow pump transfers the powder paint from the tote to the virgin hopper by positive pressure air flow.

The apparatus can include a second positive pressure air flow pump connected to the virgin hopper, a first multidirectional valve connected to the second positive pressure air flow pump, and at least one mix hopper connected to the first multidirectional valve. The second positive pressure air flow pump transfers powder paint from the virgin hopper through the first multidirectional valve to the at least one mix hopper.

The apparatus can include a reclaim hopper to contain powder paint. A third positive pressure air flow pump can be connected to the reclaim hopper. A second multidirectional valve connects to the third positive pressure air flow pump. The third positive pressure air flow pump transfers the powder paint from the reclaim hopper through the second multidirectional valve to the at least one mix hopper.

The apparatus can include fourth and/or fifth positive pressure air flow pumps connected to the virgin hopper. Third and fourth multidirectional valves can connect to the fourth and fifth positive pressure air flow pumps, respectively, and first and second groups of multidirectional valves can be connected to the third and fourth multidirectional valves, respectively. The fourth positive pressure air flow pump can transfer powder paint from the virgin hopper through the third multidirectional valve and through the first group of multidirectional valves to one or more final feed hoppers and/or positive pressure air flow final feed powder pumps located in a first position. The fifth positive pressure air flow pump can transfer powder paint from the virgin hopper through the fourth multidirectional valve and through the second group of multidirectional valves to one or more final feed hoppers and/or positive pressure air flow final feed powder pumps located in a second position.

The apparatus can include sixth and seventh positive pressure air flow pumps connected to the at least one mix hopper. Fifth and sixth multidirectional valves can be connected to the sixth and seventh positive pressure air flow pumps, respectively. Third and fourth groups of multidirectional valves can be connected to the fifth and sixth multidirectional valves, respectively. The sixth positive pressure air flow pump transfers powder paint from the at least one mix hopper through the fifth multidirectional valve and through the third group of multidirectional valves to one or more final feed hoppers and/or positive pressure air flow final feed powder pumps. The seventh positive pressure air flow pump transfers powder paint from the at least one mix hopper through the sixth multidirectional valve and through the fourth group of multidirectional valves to one or more final feed hoppers and/or positive pressure air flow final feed powder pumps.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic view of a paint flow pathway through various components according to an embodiment of the invention;

FIG. 2 is a side view of a two-way multidirectional valve;

FIG. 3 is a side view of a three-way multidirectional valve;

FIG. 4A is a side view of a four-way multidirectional valve;

FIG. 4B is a perspective view of a four-way multidirectional valve;

FIG. 5A is a side view of an eight-way multidirectional valve;

FIG. 5B is a perspective view of an eight-way multidirectional valve; and

FIG. 6 is a view of an apparatus to transfer powder paint from a powder paint bag or tote to a primary virgin hopper.

### DETAILED DESCRIPTION

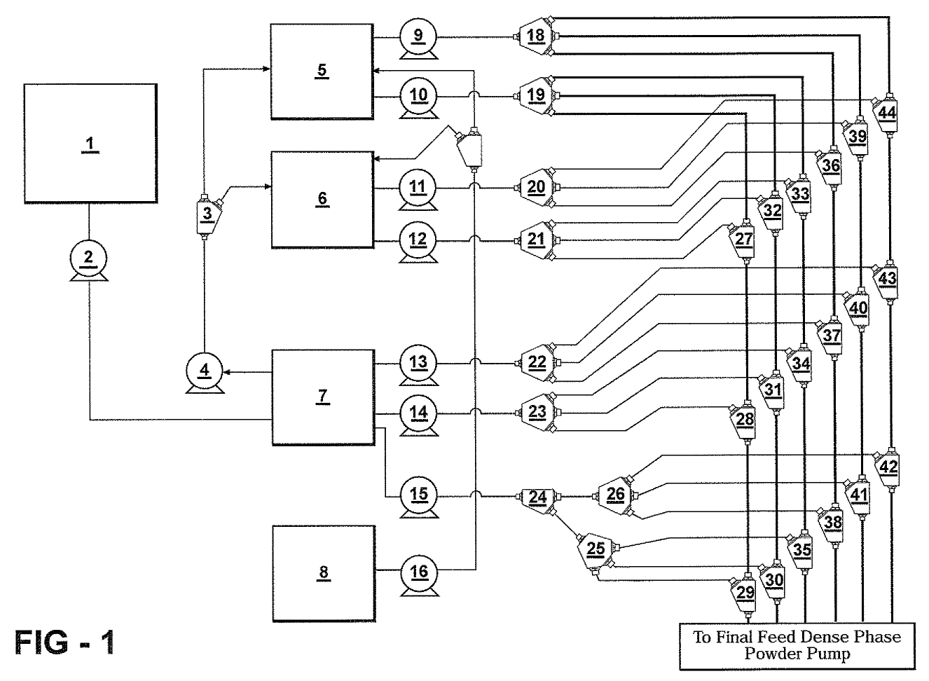

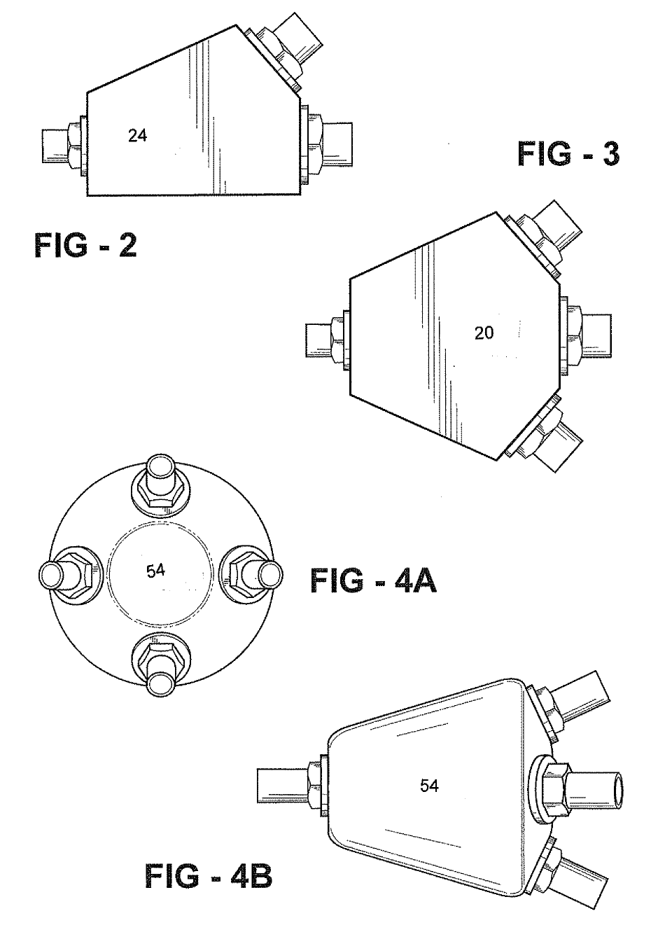

This application claims the benefit of U.S. Provisional Patent Applications Nos. 60/811,813 and 60/813,578, the disclosures of which are hereby incorporated by reference in their entirety. A powder paint delivery method according to an embodiment of the invention employs a dense phase powder transfer with no wearing surfaces to cause variation in flow over time due to erosion and an apparatus to practice this method. In one embodiment, as shown in FIG. 1, a positive pressure air flow powder pump 2 provides positive pressure air volume or flow (hereafter “volume”) to transfer paint powder (hereafter “powder”) from a bag or tote 1 to a virgin hopper 7. Positive pressure air flow powder pump 2, and all other positive pressure air flow powder pumps disclosed herein, can be any positive pressure air flow pump system to be selected based on use of minimal compressed air, and application of only low forces on the powder to minimize or eliminate the damage caused during transportation of the powder between first and second locations. Positive pressure air flow powder pump 4 transfers powder from the virgin hopper 7 through a two-way multidirectional valve 3. By way of example and not limitation, a two-way multidirectional valve is shown in FIG. 2. It should be recognized that any multidirectional valve known to those of ordinary skill in the art can be used without departing from the scope of the invention. Multidirectional valve 3 directs powder to either a first mix hopper 5 or a second mix hopper 6.

Positive pressure air flow powder pump 9 transfers powder from the first mix hopper 5 through three-way multidirectional valve 18 to final feed hoppers and/or positive pressure air flow final feed powder pumps located in a first location in a powder booth through a group of two-way multidirectional valves (36, 37, 38, 39, 40, 41, 42, 43 and 44). By way of example and not limitation, a three-way multidirectional valve is shown in FIG. 3. It should be recognized that any three-way multidirectional valve known to those of ordinary skill in the art can be used without departing from the scope of the invention. Simultaneously, positive pressure air flow powder pump 10 can transfer powder from the first mix hopper 5 through three-way multidirectional valve 19 to the final feed hoppers and/or positive pressure air flow final feed powder pumps located in a second location in a powder booth through a group of two-way multidirectional valves (27, 28, 29, 30, 31, 32, 33, 34 and 35). In a like manner, positive pressure air flow powder pump 11 transfers powder from the second mix hopper 6 through three-way multidirectional valve 20 to the final feed hoppers and/or positive pressure air flow final feed powder pumps located in the first location in a powder booth through a group of two-way multidirectional valves (36, 37, 38, 39, 40, 41, 42, 43 and 44) while, simultaneously, positive pressure air flow powder pump 12 can transfer powder from the second mix hopper 6 through three-way multidirectional valve 21 to the final feed hoppers and/or positive pressure air flow final feed powder pumps located in the second location in a powder booth through a group of two-way multidirectional valves (27, 28, 29 30, 31, 32, 33, 34 and 35).

The powder can also be transferred from the virgin hopper 7 directly to the final feed hoppers and/or positive pressure air flow final feed powder pumps located in the powder booth, bypassing the mix hoppers 5 and 6. Positive pressure air flow powder pump 13 can transfer powder from the virgin hopper 7 through three-way multidirectional valve 22 to the final feed hoppers and/or positive pressure air flow final feed powder pumps located in the first location in a powder booth through a group of two-way multidirectional valves (37, 38, 40, 41, 42, and 43). Positive pressure air flow powder pump 14 can also transfer powder from the virgin hopper 7 through three-way multidirectional valve 23 to the final feed hoppers and/or positive pressure air flow final feed powder pumps located in the second location in a powder booth through a group of two-way multidirectional valves (28, 29, 30, 31, 34 and 35). Positive pressure air flow powder pump 15 can transfer powder from the virgin hopper 7 through two-way multidirectional valve 24 to two three-way multidirectional valves 26 and 25. Multidirectional valve 26 can direct powder to the final feed hoppers and/or positive pressure air flow final feed powder pumps located in the first location in a powder booth through a group of two-way multidirectional valves (38, 41, and 42), and multidirectional valve 25 can direct powder to the final feed hoppers and/or positive pressure air flow final feed powder pumps located in the second location in a powder booth through a group of two-way multidirectional valves (29, 30 and 35).

A reclaim hopper 8 can also supply powder to the mix hoppers 5, 6. Positive pressure air flow powder pump 16 can transfer powder from the virgin hopper 7 to a two-way multidirectional valve 17. Multidirectional valve 17 can direct powder to either the first mix hopper 5 or the second mix hopper 6.

Bag or tote 1, virgin hopper 7, reclaim hopper 8, mix hoppers 5 and 6, as well as positive pressure air flow powder pumps 2, 4, 9-16, and multidirectional valves 3, 17-44 would normally be located in a powder kitchen room, which is separate from the powder booth, though the rooms may be located in any location desired necessary to practice the invention.

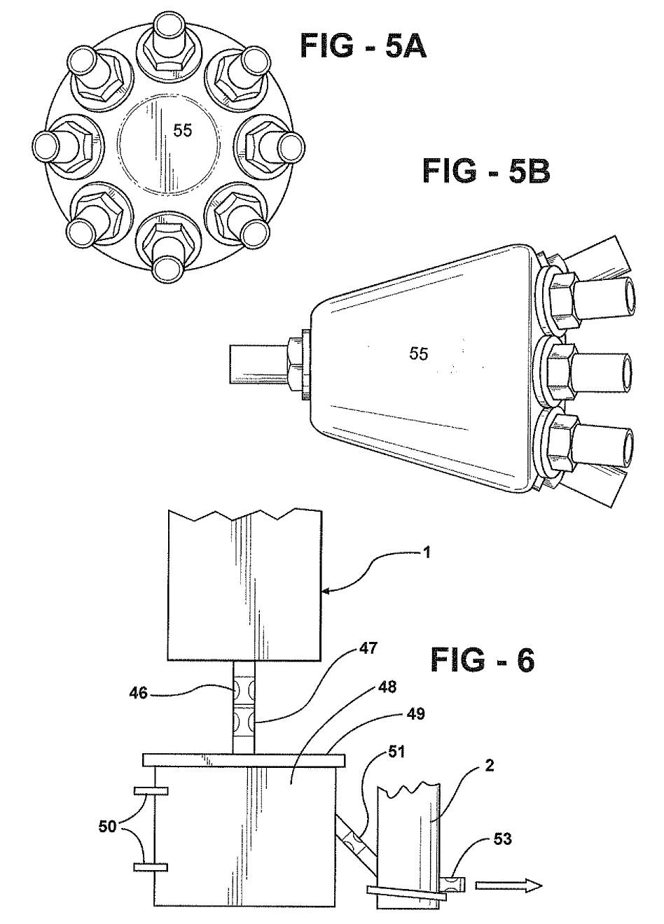

A four-way multidirectional valve 54 (as shown in FIGS. 4A and 4B), an eight-way multidirectional valve 55 (as shown in FIGS. 5A and 5B), or any multidirectional valves known to those of ordinary skill in the art can be substituted for the three-way multidirectional valves (18-23, 24 and 25) without departing from the scope of the present invention. Such a substitution would allow paint lines to be directed to other locations in a powder booth or would allow additional paint lines to be directed to the first and second locations in a powder booth as desired.

FIG. 6 illustrates an apparatus for transferring powder paint between first and second locations. The apparatus includes a positive pressure air flow powder pump 2 to move powder from a bag or tote 1 to the virgin hopper (not shown in FIG. 6). Powder is gravity fed from the bag or tote 1 through pinch valves 46 and 47, and through sieve 49 to an intermediate hopper 48. Level sensors 50 control powder levels inside the intermediate hopper 48. From intermediate hopper 48, the powder is gravity fed into positive pressure air flow powder pump 52 though pinch valve 51, and then from the positive pressure air flow powder pump 2 through pinch valve 53 to the virgin hopper 7 (not shown in FIG. 6).

The resultant powder flow rate in an apparatus using the disclosed method is a function of the positive volume of air injected inside the apparatus and of either of the following: A) the timing that the powder is allowed to gravity feed into the apparatus or B) of the powder mass supplied into the apparatus from the virgin hopper 7, mix hoppers 5, 6, or reclaim hopper 8 based on mass differences measured by load cell measuring devices.

Although other variations and modifications of the above disclosure may be presented without departing from the spirit and scope of the novel concepts here presented, the embodiments outlined herein contain in whole or in part the essential features of what is claimed. While the apparatus has been described in connection with what is presently considered to be the most practical and preferred embodiments, it is to be understood that the apparatus is not to be limited to the disclosed embodiments but, on the contrary, is intended to cover various modifications and equivalent steps and arrangements included within the spirit and scope of the invention and any appended claims.

What is claimed is:

1. A method for paint powder transportation through a distance between first and second locations comprising:
supplying paint powder from a container located at a first location;
transferring a dense phase paint powder from the first location to a second location with a positive pressure air flow with no wearing surfaces to cause variation in flow over time due to erosion; and
delivering paint powder to a container located at a second location.

2. The method of claim 1 wherein the positive pressure air flow transfers paint powder from a reclaim hopper through a multidirectional valve to at least one mix hopper.

3. The method of claim 1, wherein the positive pressure air flow transfers the paint powder from a tote to a hopper.

4. The method of claim 3, wherein the hopper is a virgin hopper.

5. The method of claim 4 further comprising:
transferring paint powder with a second positive pressure air flow from the virgin hopper through a multidirectional valve to at least one mix hopper

6. The method of claim 3 further comprising:
transferring paint powder with a second positive pressure air flow from the hopper through at least one multidirectional valve to at least one final feed hopper and positive pressure air flow final feed powder pump located in a first position.

7. The method of claim 6 further comprising:
transferring paint powder with a third positive pressure air flow from the hopper through at least one multidirectional valve to at least one final feed hopper and positive pressure air flow final feed powder pump located in a second position.

8. The method of claim 6, wherein the second positive pressure air flow transfers paint powder from the hopper through at least one multidirectional valve to at least one final feed hopper and positive pressure air flow final feed powder pump located in the first position.

9. The method of claim 8, wherein the second positive pressure air flow transfers the paint powder from the hopper through at least one multidirectional valve to at least one final feed hopper and positive pressure air flow final feed powder pump located in a second position.

10. A method for paint powder transportation through a distance between first and second locations comprising:
transferring paint powder with a first positive pressure air flow from a tote to a first hopper;
transferring paint powder with a second positive pressure air flow from the first hopper through at least one multidirectional valve to a mix hopper selected from a group consisting of a first mix hopper, a second mix hopper, and any combination thereof;
transferring paint powder with a third positive pressure air flow from a reclaim hopper through at least one multidirectional valve to the mix hopper selected from a group consisting of the first mix hopper, the second mix hopper, and any combination thereof;
transferring paint powder with a fourth positive pressure air flow from the mix hopper through at least one multidirectional valve to at least one final feed hopper and positive pressure air flow final feed powder pump located in a first position; and
transferring paint powder with a fifth positive pressure air flow from the mix hopper through at least one multidirectional valve to at least one final feed hopper and positive pressure air flow final feed powder pump located in a second position.

11. An apparatus for paint powder transportation through a distance between first and second locations comprising:
a container located at a first location for supplying paint powder;
a positive pressure air flow pump for transferring paint powder by positive pressure air flow between the first location and a second location; and
a container located at the second location for receiving paint powder.

12. The apparatus of claim 11, further comprising:
the positive pressure air flow pump connected to a tote operable to contain powder;
the positive pressure air flow pump connected to a hopper operable to contain powder; and
wherein the positive pressure air flow pump is operable to transfer the powder from the tote to the hopper by positive pressure air flow.

13. The apparatus of claim 12, wherein the hopper is a virgin hopper.

14. The apparatus of claim 12, further comprising:
a second positive pressure air flow pump connected to the hopper;
a multidirectional valve connected to the second positive pressure air flow pump;
a mix hopper; and
the second positive pressure air flow pump operable to transfer the powder from the hopper via the multidirectional valve to a mix hopper.

15. The apparatus of claim 14, further comprising:
a reclaim hopper operable to contain power;
a third positive pressure air flow pump connected to the reclaim hopper;
a second multidirectional valve connected to the third positive pressure air flow pump;
a mix hopper; and
the third positive pressure air flow pump operable to transfer the powder from the reclaim hopper via the second multidirectional valve to the mix hopper.

16. The apparatus of claim 12, further comprising:
a third positive pressure air flow pump connected to the hopper;
a second multidirectional valve connected to the third positive pressure air flow pump;
a plurality of multidirectional valves connected to the second multidirectional valve;
a plurality of final feed hoppers/positive pressure air flow final feed powder pumps located in a first position; and
wherein the third positive pressure air flow pump is operable to transfer the powder from the hopper via the second multidirectional valve and via the plurality of multidirectional valves to the plurality of final feed hoppers/positive pressure air flow final feed powder pumps.

17. The apparatus of claim 16, further comprising:
a fourth positive pressure air flow pump connected to the hopper;
a third multidirectional valve connected to the fourth positive pressure air flow pump;
a second plurality of multidirectional valves connected to the third multidirectional valve;
a second plurality of final feed hoppers/positive pressure air flow final feed powder pumps located in a second position; and
wherein the fourth positive pressure air flow pump is operable to transfer the powder from the hopper via the third multidirectional valve and via the second plurality of multidirectional valves to the second plurality of final feed hoppers/positive pressure air flow final feed powder pumps.

18. An apparatus for paint powder transportation through a distance between first and second locations comprising:
a first positive pressure air flow pump connected to a tote operable to contain powder;
the first positive pressure air flow pump connected to a virgin hopper operable to contain powder;
wherein the first positive pressure air flow pump is operable to transfer the powder from the tote to the virgin hopper by positive pressure air flow;
a second positive pressure air flow pump connected to the virgin hopper;
a first multidirectional valve connected to the second positive pressure air flow pump;
at least one mix hopper connected to the first multidirectional valve;
the second positive pressure air flow pump operable to transfer the powder from the virgin hopper via the first multidirectional valve to the at least one mix hopper;
a reclaim hopper operable to contain power;
a third positive pressure air flow pump connected to the reclaim hopper;
a second multidirectional valve connected to the third positive pressure air flow pump and to the at least one mix hopper;
the third positive pressure air flow pump operable to transfer the powder from the reclaim hopper via the second multidirectional valve to the at least one mix hopper;
a fourth positive pressure air flow pump connected to the virgin hopper;
a third multidirectional valve connected to the fourth positive pressure air flow pump;
a first plurality of multidirectional valves connected to the third multidirectional valve;
a first plurality of final feed hoppers/positive pressure air flow final feed powder pumps located in a first position; wherein the fourth positive pressure air flow pump is operable to transfer the powder from the virgin hopper via the third multidirectional valve and via the first plurality of multidirectional valves to the first plurality of final feed hoppers/positive pressure air flow final feed powder pumps;
a fifth positive pressure air flow pump connected to the virgin hopper;
a fourth multidirectional valve connected to the fifth positive pressure air flow pump;
a second plurality of multidirectional valves connected to the fourth multidirectional valve;
a second plurality of final feed hoppers/positive pressure air flow final feed powder pumps located in a second position; wherein the fifth positive pressure air flow pump is operable to transfer the powder from the virgin hopper via the fourth multidirectional valve and via the second plurality of multidirectional valves to the second plurality of final feed hoppers/positive pressure air flow final feed powder pumps;
a sixth positive pressure air flow pump connected to the at least one mix hopper;
a fifth multidirectional valve connected to the sixth positive pressure air flow pump;
a third plurality of multidirectional valves connected to the fifth multidirectional valve;
wherein the sixth positive pressure air flow pump is operable to transfer the powder from the at least one mix hopper via the fifth multidirectional valve and via the third plurality of multidirectional valves to the first plurality of final feed hoppers/positive pressure air flow final feed powder pumps;
a seventh positive pressure air flow pump connected to the at least one mix hopper;
a sixth multidirectional valve connected to the seventh positive pressure air flow pump;
a fourth plurality of multidirectional valves connected to the sixth multidirectional valve; and
wherein the seventh positive pressure air flow pump is operable to transfer the powder from the at least one mix hopper via the sixth multidirectional valve and via the fourth plurality of multidirectional valves to the second plurality of final feed hoppers/positive pressure air flow final feed powder pumps.

19. An apparatus for paint powder transportation through a distance between first and second locations comprising:
a network of paint powder distribution conduits having a plurality of multidirectional valves for selectively controlling open pathways for transporting paint powder between a first location and a second location; and
at least one positive pressure air flow pump for transferring paint powder through the network of paint powder distribution conduits by positive pressure air flow between the first location and the second location.

20. The apparatus of claim 19, wherein the pump is connected to at least one device selected from a group consisting of a bag, a tote, a virgin hopper, a multidirectional valve, a mix hopper, a reclaim hopper, a final feed hopper, a positive pressure air flow final feed powder pump, and any combination thereof.
